(19) United States
(12) Patent Application Publication
(10) Pub. No.: US 2013/0129848 A1
(43) Pub. Date: May 23, 2013

(54) INSECT-REPELLENT OR INSECTICIDAL COMPOSITION COMPRISING EXTRACT OR FRACTION OF PHELLODENDRON AMURENSE AS AN EFFECTIVE INGREDIENT FOR CONSERVATION OF CULTURAL HERITAGE

(71) Applicants: Mi Hwa Jung, Daejeon (KR); Jin Young Hong, Daejeon (KR); Chang Wook Jo, Daejeon (KR); Young-Hee Kim, Daejeon (KR); Jung Eun Choi, Daejeon (KR); So Young Jeong, Daejeon (KR); Soon Hyoung Ghang, Seoul (KR)

(72) Inventors: Mi Hwa Jung, Daejeon (KR); Jin Young Hong, Daejeon (KR); Chang Wook Jo, Daejeon (KR); Young-Hee Kim, Daejeon (KR); Jung Eun Choi, Daejeon (KR); So Young Jeong, Daejeon (KR); Soon Hyoung Ghang, Seoul (KR)

(21) Appl. No.: 13/814,195

(22) PCT Filed: Sep. 10, 2010
(86) PCT No.: PCT/KR2010/006158

§ 371 Date: Feb. 4, 2013

(30) Foreign Application Priority Data
Aug. 5, 2010 (KR) 10-2010-0075410

(51) Int. Cl. A01N 65/36

(52) U.S. Cl. CPC A01N 65/36
USPC 424/769

(57) ABSTRACT

An insect-repellent and insecticidal composition comprising extract or fraction of phellodendron amurense as an active ingredient is provided. The extract of phellodendron amurense, or the hexane (Hex) extract, methylene chloride (MC) fraction, or ethyl acetate (EtOAc) fraction provides insect-repellent or insecticidal activities against lasioderma serricorne which harms tobacco, crops, paper, clothes or wood, or against sitophilus oryzae which has strong tolerance to insecticide, and thus can be effectively applied as an insect-repellent or insecticidal composition to conserve wooden furniture, an old house, or many organic cultural heritages.

### TECHNICAL FIELD

The present invention relates to an insect-repellent or insecticidal composition having an extract or fraction of phellodendron amurense as an effective ingredient for conservation of cultural heritage.

### BACKGROUND ART

Organic cultural heritage occupies 28.5% of national treasures and 44.1% of treasures of Korea, and conserving organic cultural heritage from insects and microorganism has become a significant issue. Compared to inorganic cultural heritage such as metal, stone, pottery and earthenware, the organic cultural heritage such as textile, paper, or wood is intrinsically apt to be harmed by biological factors such as microorganism, insects, etc. Biological degradation of organic cultural heritage involves not only the contamination of the appearance of the cultural assets, or the destruction of letters or decorations, which lowers the artistic value of the cultrual heritage, but also causes serious destruction of structures.

Many woods seriously suffer from wood-rotting fungi, which cause severe damages in structural or aesthetic features thereof. Wood-rotting fungi include white-rot fungi, brown-rot fungi, and mould and cause various wood damages such as wood drying, decomposition and crack, sponge-like structure, fuzzy or powdery surface growths, or discoloration.

Lasioderma serricorne, commonly known as a tobacco beetle, appears 2˜3 times a year and widely known to damage tobacco, grains, paper, cloths, woods, etc. Also, inhabiting in wooden cultural assets and organic moving cultural heritage, this insect causes structural damages to cultural heritages. In recent, the National Research Institute of Cultural Heritage (NRICH) reported the cases of wooden cultural heritage damaged by termites, tobacco beetles, etc. and conducted insect extermination project.

Rice weevil (Sitophilus oryzae (L.)) is widely known for the strong insecticidal resistancy and is distributed worldwide. This insect especially harms the safety of the stored crops, and even degrades the quality and quantity of the stored crops in combination with changes in temperature and humidity of the storage environment. Rice weevil also induces the drastic growth of mold to cause the grains to decay, and causes production of mycotoxin to threaten food safety.

The extermination of Rice weevil in stored grains is important, and it is also important in the perspective of food sanitation to prevent and inhibit the decomposition and mycotoxin of mold (Yoon Tae-Joong et al., Korean J. appl. Entomol., 2003, 42(4);329-334)

Gas fumigation is the most widely used to exterminate pests and insects inhabiting in cultural heritage. Now, insecticidal fumigation gas such as methyl bromide or sulfuryl fluoride, sterilizing fumigation gas such as ethylene oxide or propylene oxide, insecticidal-sterilizing fumigation gas such as the mixture of methyl bromide and ethylene oxide, and sublimable insecticidal-sterilizing p-formaldehyde such as p-dichlorobenzene, dichlovos, camphor, clover oil, and sublimable sterilizing or mycostats such as thymol are used as sterilizer.

Among these, the mixed gas of ethylene oxide and methyl bromide as insecticide, is widely used to prevent germs and insects which harm the cultural heritages.

The gas fumigations are stable and show rapid effects, but do not last long, so additional preservative treatment is required particularly in wooden structures. Methyl bromide, the widely used toxic chemical which is colorless and odorless, is regulated under environmental concerns, since this is 50 times destructive to ozone layer than chlorofluorocarbon (CFC). For now, methyl bromide is rarely used in many developed countries, expect for a few cases, such as the use in quarantines.

Due to the problems of using chemicals in preserving organic cultural heritage, such as discoloration, peeling-off of pigment and dye, and adverse health effects, demands for the preservatives based on natural substances are increasing.

The natural substances reported as having insect-repellent and insecticidal activities so far are as follows.

According to the research on antibiotic effects of the extracts of medicinal plants, tangerine peel, forsythia fruit, lappa fruit, gentiana macrophylla pallas, picrorrhizae rhizoma, siegesbockia herb, nelumbo nucifera gaertner, rosa laevigata, caesalpinia sappan L., or nutmeg are reported as providing distinctive inhibiting effects on microorganism, and garlic extract, onion extract, chili pepper extract, white radish extract are reported as inhibiting the growth of escherichia coli, salmonella thyposa, shigella dysentriae, or staphylococcus aureus.

In Japan, experiment on the antibacterial activity against pathogenic fungi of cryptomeria japonica extract was conducted. In France, phenolic extract from heartwood of European oak was researched for its repelling activity against white rot fungus, and recently, substance extracted from the heart wood of eperua was applied to white rot fungus to experiment the activity of the extract. In U.S, repelling effect of solvent extract of eperua heartwood against the brown-rot fungi and the insects was confirmed. Additionally, hinokitiol, an extract of Taiwanese chamaecyparis obtuse, was discovered to have strong antibacterial effect on not only dust fungus such as yeast fungus, but also basidiomycetes, which are the wood-rotting fungi.

There are numerous studies conducted regarding new insecticides that utilize the secondary metabolites of the plants. One of these studies for natural substance-based insecticides confirmed that, physostigmine, which is the poisonous substance isolated from the African leguminous plant, i.e., physostgima venenosum seed, inhibits particularly acetylcholinesterase, and another study reported that pyrethrin, which is insecticidal substance contained in the seed cases of perennial plant pyrethrum, affects membrane permeability of K⁺ and Na⁺ ion in nervous system of insects, intervening normal nerve stimulation, and thus killing the insects.

Korean Patent Publication No. 2002-0063375 discloses biocide composition comprising volatile extracts of natural medicines including eugenia caryophyllata thunberg, boswellia carterii birdwood and star anise, as effective components for conservation of cultural properties, and method for conserving cultural properties using the same. Korean Patent Publication No. 2002-0087568 discloses insecticidal composition containing extract from plants including acorus gramineus, acorus calamus var. angustatus, cinnamomum camphora, agastache rugosa, cinnamomum sieboldii, cinnamomum cassia, kaempferia galangal, illicium vernum, angelica dahurica, cnidium officinale, piper nigrum, zanthoxylum coreanum, zanthoxylum piperitum, zanthoxylum schinifolium, eugenia carrophillata, nardostachys chinensis, tiliaamurensis, lysimachia davurica, aquillaria agallocha, agastacherugosa, mustard oil, brassica juncea, horseradish oil, cocholeria aroracia, and insecticidal chemical compound extracted from the said plants.

Phellodendron amurense (RUPR) are endemic in Korea, Japan, or China and plants in the same genus include: phellodendron amurense var. molle NAKAI W. LEE, phellodendron amurense var. sachalinense FR. SCHMIDT, P. molle NAKAI, P. sachalinense SAKGENT, or P. insulare NAKAI. P. chinensis is popular around Yunnam and Hubei, China, P. sacharinensis is in Sichuan, china, and P. wilsoni is in Taiwan. The phellodendri cortex is the bark of phellodendron amurense and plants in the same genus, and contains yellow, or white brown bleaching materials and a plurality of alkaloids in an amount of 1.5˜4.5%. The main component of the alkaloids is berberine. Phellodendri cortex also includes other alkaloids including guanidine, jatrorrizine, magnoflorine, phellodendrine, candicine, palmatine, menisperine, or n-methylisocorydinum, and obacunone, obaculactone, dictamnolide, obacunonic acid, lumicaerulei acid, 7-dehydrostigmasterol, β-sitosterol, or campesterol. Due to strong antibacterial activity, hypotensive effect, and effects of central nervous system depression, acetylcholine reinforcement, and anti-inflammation, the components have been used for treatment of bone disease and jaundice according to Bencao Gangmu or in medicinal field. Additionally, the phellodendri cortex effective in treating typhoid, cholera, strong stomach, or seminal plasma, and the bark of the components are used for the medicine of bitter stomachic, intestinal disorders, anti-inflammatory convergentia, and used as bitter stomachic, digestive, or anti-inflammatory astringent for treating gastroenteritis, stomachache, or jaundice (Jung Bo-sup, Shin Min-kyo, Pp. 790˜791, Hyang-Yak-Dae-Sa-Jeon (‘The encyclopedia of Korean medicines’), Young-Lim publishing company, 1998).

Therefore, the inventors of the present invention studied the extracted bioactive substances from a wide range of natural sources in pursuit of the substance which can provide strong insect-resistant properties and insecticidal activities, and confirmed the excellent insect-resistant and insecticidal properties of the extract or fraction of phellodendron amurense and thus completed the present invention.

### DISCLOSURE OF INVENTION

### Technical Problem

It is an object of the present invention to provide an insect-resistant or insecticidal composition comprising an extract from phellodendron amurense as an effective ingredient.

It is another object of the present invention to provide an insect-resistant or insecticidal composition comprising organic solvent of a fraction of phellodendron amurense as an effective ingredient.

It is yet another object of the present invention to provide a conservation method of cultural heritage using said compositions.

### Solution to Problem

In order to accomplish one of said objects, an insect-repellent or insecticidal composition comprising an extract from phellodendron amurense as an effective ingredient, is provided.

Furthermore, an insect-repellent or insecticidal composition comprising organic solvent of a fraction of phellodendron amurense as an effective ingredient, is provided.

Furthermore, a conservation method of cultural heritage using said compositions, is provided.

### Advantageous Effects of Invention

An extract of phellodendron amurense or hexane (Hex), methylene chloride (MC) or ethyl acetate (EtOAc) fraction therefrom according to the present invention provides insecticidal or insect-repellent activities particularly against Lasioderma serricorne that damage tobacco, cereals, papers, clothes or woods, and against Sitophilus oryzae which harms the crops and has strong tolerance against insecticides, and thus is applicable efficacaciously as insecticidal or insect-repellent compositions to conserve wooden furniture, old house or many organic cultural heritage.

### BRIEF DESCRIPTION OF DRAWINGS

FIG. 1 is a graphical indication of the average mortality number of lasioderma serricorne by the addition of an extract of phellodendron amurense according to an example of the present invention;

FIG. 2 is a graphical indication of the average mortality number of sitophilus oryzae by the addition of an extract of phellodendron amurense according to an example of the present invention;

FIG. 3 is a graphical indication of the average mortality number of lasioderma serricorne by the addition of an extract or fraction of bark of phellodendron amurense according to an example of the present invention;

FIG. 4 is a graphical indication of the average mortality number of lasioderma serricorne by the addition of an extract or fraction of leaf of phellodendron amurense according to an example of the present invention;

FIG. 5 is a graphical indication of the average mortality number of lasioderma serricorne by the addition of an extract or fraction of fruit of phellodendron amurense according to an example of the present invention;

FIG. 6 a graphical indication of the average mortality number of sitophilus oryzae according to the addition of an extract or fraction of bark of phellodendron amurense according to an example of the present invention;

FIG. 7 is a graphical indication of the average mortality number of sitophilus oryzae according to the addition of an extract or fraction of leaf of phellodendron amurense according to an example of the present invention; and

FIG. 8 is a graphical indication of the average mortality number of sitophilus oryzae according to the addition of an extract or fraction of fruit of phellodendron amurense according to an example of the present invention.

### BEST MODE FOR CARRYING OUT THE INVENTION

The present invention will be explained in greater detail below.

The present invention provides an insect-repellent or insecticidal composition comprising an extract of phellodendron amurense as an effective ingredient.

In obtaining the composition, the extract may be obtained from bark, wood, leaf or fruit of phellodendron amurense with C₁˜C₄ of ethanol, and preferably, with methanol (MeOH).

The extract may be obtained at 18˜32° C., and preferably at 20˜27° C., although the temperature is not strictly limited.

Specifically, bark, wood, leaf and fruit of phellodendron amurense are cut and put into extraction vessels respectively, and after methanol (MeOH) is added, the extraction vessels are kept in a room temperature for one week to obtain extracts. This process may be repeated several times to improve the efficiency of extract of phellodendron amurense. The extracts are left for a predetermined time and filtered through filter paper or the like, to prepare extracts of bark, wood, leaf and fruit.

Additionally, the extracts of phellodendron amurense may be vacuum concentrated with rotary vacuum evaporator (EYELA, Japan).

Furthermore, the present invention provides an insect-repellent or insecticidal composition comprising an organic solvent fraction of phellodendron amurense as effective ingredient.

The organic solvent fraction may desirably be hexane (Hex) fraction, methylene chloride (MC) fraction, or ethyl acetate (EtOAc) fraction.

A preparation method of an organic solvent fraction of phellodendron amurense may include:

(S1) obtaining an extract of phellodendron amurense;

(S2) obtaining hexane (Hex) fraction by mixing the phellodendron amurense extract (S1) with water and hexane (Hex) and separating the mixture into a water layer and an organic layer using separating funnel;

(S3) obtaining methylene chloride (MC) fraction by mixing the separated water layer of (S2) with methylene chloride (MC) and separating the mixture into a water layer and an organic layer; and

(S4) obtaining water fraction and ethyl acetate (EtOAc) fraction by mixing the separated water layer of (S3) with ethyl acetate (EtOAc) fraction and separating the mixture into a water layer and an organic layer using a separating funnel.

The extract of (S1) may be prepared or purchased, but the manner of obtaining the extract is not strictly limited.

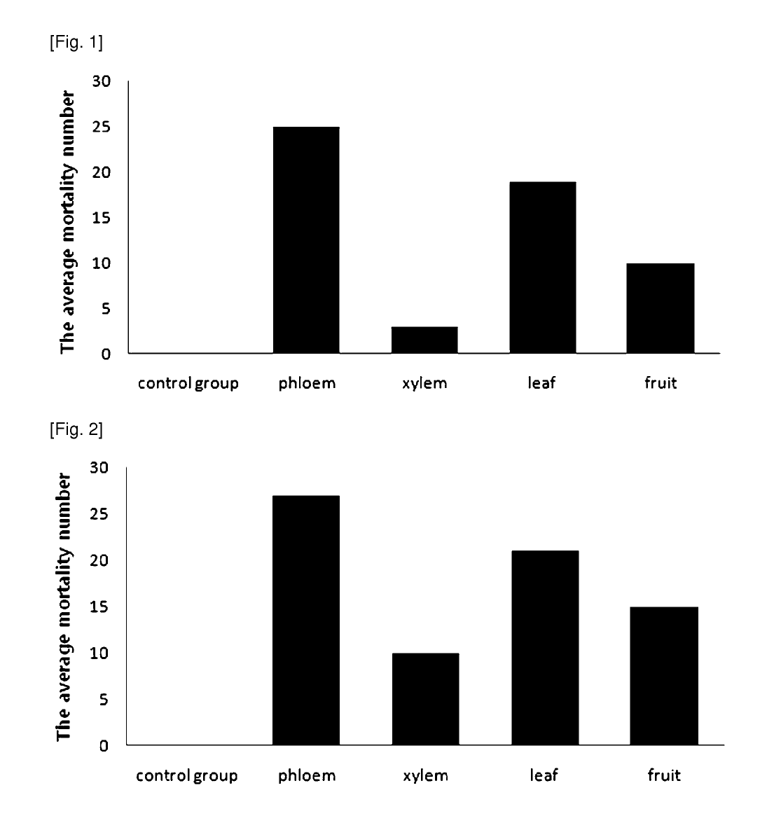

An extract of phellodendron amurense was added to Lasioderma serricorne and the average mortality number of Lasioderma serricorne was measured to measure the insect-repellent or insecticidal activities of the phellodendron amurense extract against Lasioderma serricorne. 25 out of 30 were killed when the bark extract was added (83.33% of mortality rate), 3 killed by wood extract (10.00% of mortality rate), 19 killed by leaf extract (63.33% of mortality rate), and 10 killed by fruit extract (33.33% of mortality rate). Regarding the extracts of wood and fruit which exhibited relatively lower mortality rate, it was confirmed that lasioderma serricorne avoided the extracts and showed degraded vitality compared to control groups (see Table 1 and FIG. 1).

An extract of phellodendron amurense was added to sitophilus oryzae and the average mortality number of sitophilus oryzae was measured to measure the insectrepellent or insecticidal activities of the phellodendron amurense extract against sitophilus oryzae. 27 out of 30 were killed by the bark extract (90.00% of mortality rate), 10 killed by wood extract (33.33% of mortality rate), 25 killed by leaf extract (70.00% of mortality rate), and 15 killed by fruit extract (50.00% of mortality rate). Regarding the extracts of wood and fruit which exhibited relatively lower mortality rate, it was confirmed that sitophilus oryzae avoided the extracts and showed degraded vitality compared to control groups (see Table 2 and FIG. 2).

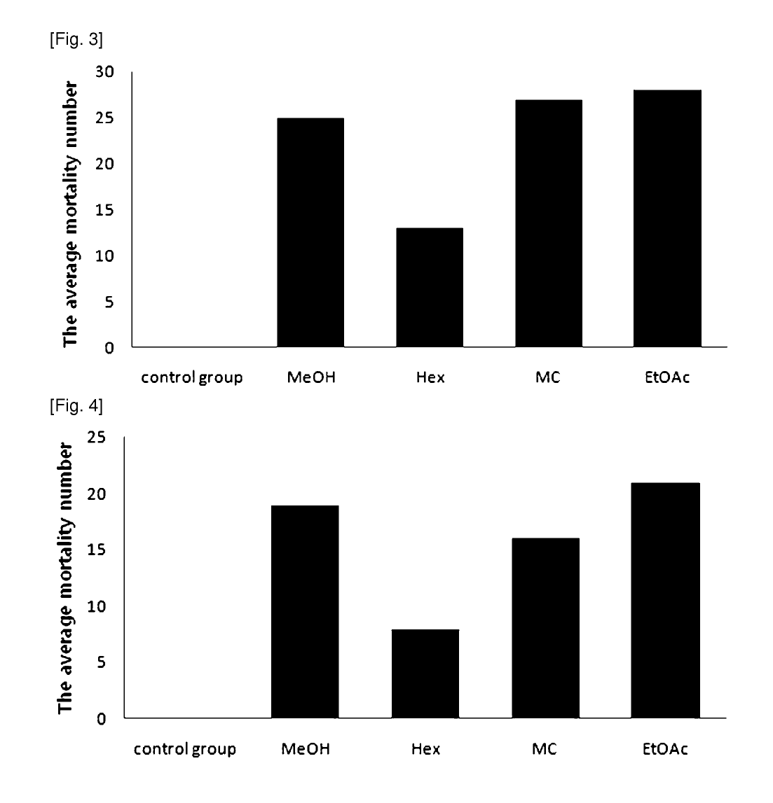

Methanol (MeOH) extract, hexane (Hex) fraction, methylene chloride (MC) fraction, or ethyl acetate (EtOAc) fraction of phellodendron amurense bark was added to lasioderma serricorne and the average mortality number of lasioderma serricorne was measured to measure the insect-repellent or insecticidal activities of methanol (MeOH) extract, hexane (Hex) fraction, methylene chloride(MC) fraction, or ethyl acetate (EtOAc) fraction of phellodendron amurense bark against lasioderma serricorne. 25 out of 30 were killed by methanol (MeOH) extract (83.33% of mortality rate), 13 killed by hexane (Hex) fraction (43.33% of mortality rate), 27 killed by methylene chloride (MC) (90.00% of mortality rate), and 28 killed by ethyl acetate (EtOAc) fraction (93.33% of mortality rate)(see Table 3 and FIG. 3).

Methanol( MeOH) extract, hexane (Hex) fraction, methylene chloride(MC) fraction, or ethyl acetate (EtOAc) fraction of phellodendron amurense leaf was added to lasioderma serricorne and the average mortality number of lasioderma serricorne was measured to measure the insect-repellent or insecticidal activities of the extract or fraction of phellodendron amurense leaf against lasioderma serricorne. 19 out of 30 were killed by methanol (MeOH) extract (63.33% of mortality rate), 8 killed by hexane (Hex) fraction (26.67% of mortality rate), 16 killed by methylene chloride (MC) fraction (53.33% of mortality rate), and 21 killed by ethyl acetate (EtOAc) fraction (70.00% of mortality rate) (see Table 4 and FIG. 4).

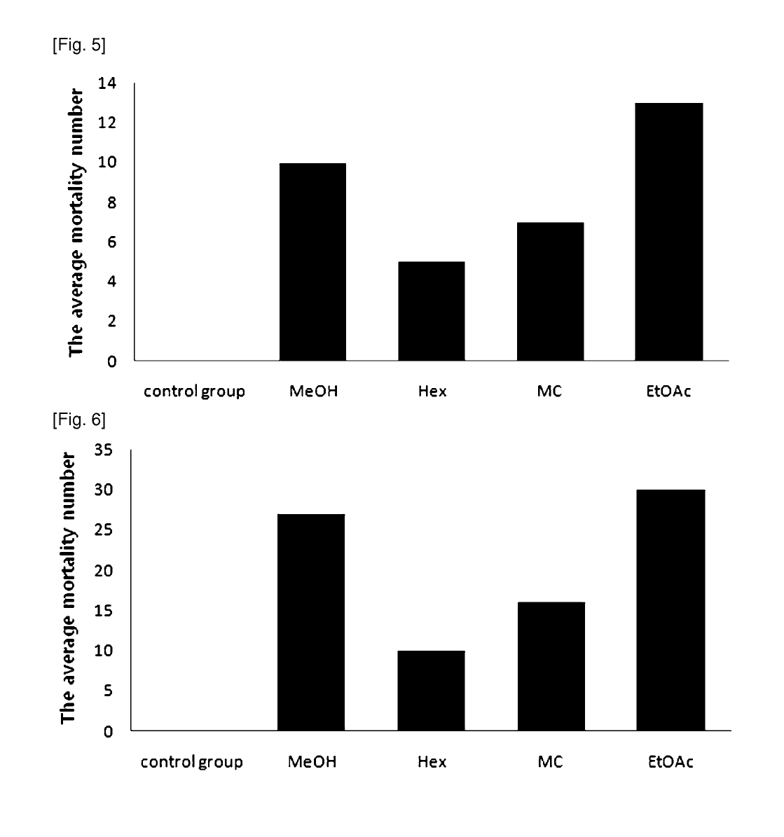

Methanol (MeOH) extract, hexane (Hex) fraction, methylene chloride (MC) fraction, or ethyl acetate (EtOAc) fraction of phellodendron amurense fruit was added to lasioderma serricorne and the average mortality number of lasioderma serricorne was measured to measure the insect-repellent or insecticidal activities of the extract or fraction of the phellodendron amurense fruit against lasioderma serricorne. 10 out of 30 were killed by methanol (MeOH) extract (33.33% of mortality rate), 5 killed by hexane (Hex) fraction (16.67% of mortality rate), 7 killed by methylene chloride (MC) fraction (23.33% of mortality rate), and 13 killed by ethyl acetate (EtOAc) fraction (43.33% of mortality rate) (see Table 5 and FIG. 5).

Methanol (MeOH) extract, hexane (Hex) fraction, methylene chloride (MC) fraction, or ethyl acetate (EtOAc) fraction of phellodendron amurense bark was added to lasioderma serricorne and the average mortality number of lasioderma serricorne was measured to measure the insect-repellent or insecticidal activities of the extract or fraction of the phellodendron amurense bark against lasioderma serricorne. 27 out of 30 were killed by methanol (MeOH) extract (90.00% of mortality rate), 10 killed by hexane (Hex) fraction (33.33% of mortality rate), 16 killed by methylene chloride (MC) fraction (53.33% of mortality rate), and 30 killed by ethyl acetate (EtOAc) fraction (100.00% of mortality rate) (see Table 6 and FIG. 6).

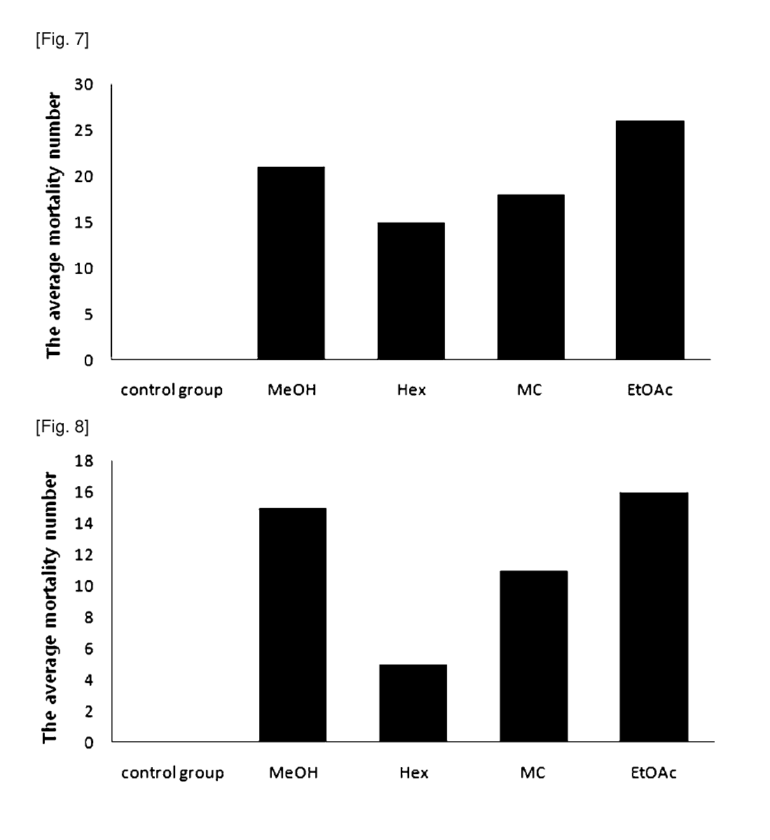

Methanol (MeOH) extract, hexane (Hex) fraction, methylene chloride (MC) fraction, or ethyl acetate (EtOAc) fraction of phellodendron amurense leaf was added to sitophilus oryzae and the average mortality number of sitophilus oryzae was measured to measure the insect-repellent or insecticidal activities of the extract or fraction of the phellodendron amurense leaf against sitophilus oryzae. 21 out of 30 were killed by methanol (MeOH) extract (70.00% of mortality rate), 15 killed by hexane (Hex) fraction (50.00% of mortality rate), 18 killed by methylene chloride (MC) fraction (60.00% of mortality rate), and 26 killed by ethyl acetate (EtOAc) fractio n(86.67% of mortality rate) (see Table 7 and FIG. 7).

Methanol (MeOH) extract, hexane (Hex) fraction, methylene chloride (MC) fraction, or ethyl acetate( EtOAc) fraction of phellodendron amurense fruit was added to sitophilus oryzae and the average mortality number of sitophilus oryzae was measured to measure the insect-repellent or insecticidal activities of the extract or fraction of the phellodendron amurense fruit against sitophilus oryzae. 15 out of 30 were killed by methanol (MeOH) extract (50.00% of mortality rate), 5 killed by hexane (Hex) fraction (16.67% of mortality rate), 11 killed by methylene chloride (MC) fraction (36.67% of mortality rate), and 16 killed by ethyl acetate (EtOAc) fraction (53.33% of mortality rate) (see Table 8 and FIG. 8).

As explained above, the extract or fraction of phellodendron amurense has superior insect-repellent or insecticidal activities toward lasioderma serricorne or sitophilus oryzae, and thus can be efficaciously applicable as the insect-repellent or insecticidal composition for conserving cultural heritage.

In one embodiment, the present invention provides a conservation method of cultural heritage, which uses a composition comprising an extract or an organic solvent fraction of phellodendron amurense as an effective ingredient.

The extract of phellodendron amurense may be obtained from bark, leaf, fruit or wood of phellodendron amurense, and the organic solvent fraction may be hexane (Hex) fraction, methylene chloride (MC) fraction or ethyl acetate (EtOAc) fraction.

In one embodiment, the cultural heritage may be an organic cultural heritage, which may include wood, paper or textile, and preferably wood cultural heritage. The composition with insect-repellent or insecticidal activities may include the pure volatible extract or the extract diluted in a predetermined concentration. The composition with insect-repellent or insecticidal activities may be applied to cultural heritages by direct spraying, coating, fumigation, air freshing, or wrapping with a wrapping paper on which a composition with insect-repellent or insecticidal activities is coated, but the method is not strictly limited thereto. The composition with insect-repellent or insecticidal activities may be in an aerosol phase for direct spraying, tincture or liquid phase for fumigation or air freshing, or gel matrix for sustained-release, but the phase of the composition is not strictly limited thereto.

The amount of composition with insect-repellent or insecticidal activities applied to the cultural heritage may differ depending on the components or applying method. By way of example, the concentration of the composition for application by air spraying, may be regulated to 50 ml/m³ or above, and preferably to 125 ml/m³ or above.

### MODE FOR THE INVENTION

The present inventive technical concept will be explained in greater detail below based on the exemplary examples which are not to be construed as limiting the present inventive concept.

### Example 1

### Preparation of Phellodendron Amurense Extract

The sample of phellodendron amurense was obtained from the nursery garden of the Environmental Greenery Bureau of Daejeon city. Specifically, 1 kg of bark, 2 kg of wood, 2 kg of leaf and 5 kg of fruit were kept in a refregirator at −20 ° C. prior to be used in the experiment. The phellodendron amurense, divided into, bark, wood, leaf and fruit portions, were dried for 3 days, and separately kept at a room temperature with 20 l of methanol for a week, extracted and filtered through a filter paper. The filtrate was vacuum concentrated with rotary vacuum evaporator (EYELA, Japan), and 105.70 g of bark, 19.82 g of wood, 76.24 g of leaf and 34.58 g of fruit were obtained.

### Example 2

### Preparation of Phellodendron Amurense Fraction

The extract of fruit, bark or leaf of Example 1 was mixed with 1 l of water and 1 l of hexane (Hex), and filtered through a separatory funnel to be divided into a water layer and an organic layer. Accordingly, hexane (Hex) fraction was obtained from the organic layer. The water fraction was mixed with 1 l of methylene chloride (MC) and filtered through a separatory funnel to be divided into a water layer and an organic layer. Accordingly, methylene chloride (MC) fraction was obtained from the organic layer. The water fraction was mixed with 1 l of ethyl acetate (EtOAc) and filtered through a separatory funnel to be divided into a water layer and an organic layer, and ethyl acetate (EtOAc) fraction was obtained from the organic layer.

### Example 3

### Preparation of Composition Comprising Extract or Fraction of Phellodendron Amurense as an Effective Ingredient

The extract of bark, wood, leaf or fruit of Example 1 or the phellodendron amurense fraction of Example 2 was melt in methanol with the concentration of 0.5 g/ml to prepare composition comprising extract or fraction of phellodendron amurense as an effective ingredient.

### Experimental Example

### Measurement of Insecticidal Activities of Extract or Fraction of Phellodendron Amurense

<1-1> Rearing of Test Insects to Measure Insecticidal Activities of Extract or Fraction of Phellodendron Amurense

Lasioderma serricorne and sitophilus oryzae were used to measure insecticidal activities of extract or fraction of phellodendron amurense.

The test insects were provided from KT&G company and cultured. The whole-wheat flour and yeast were mixed by the ratio of 95:5 in a thermo-hydrostat at 28° C. under 70%, fermented at room temperature for three days, and sterilized in an autoclave. The mixture was put into a culture bottle by the amount approximately of 1/5, cooled in a cool place, and the culture medium was solidified, and 100 of lasioderma serricorne adults were selected and cultured.

The mixture of rice and brown rice by the ratio of 1:1 was used to culture sitophilus oryzae, and culture medium was changed in one month terms at a room temperature to keep the clean environment, and prevent contamination.

<2-1> Measurement of Insect-Repellent or Insecticidal Activities of Phellodendron Amurense Extract Against Lasioderma Serricorne

Fumigation method was used to measure insecticidal activities of phellodendron amurense extract against lasioderma serricorne.

250 μl of phellodendron amurense extract of Example 3 was filtered through a filter paper and placed on Petri dishes (50 mm). 30 lasioderma serricorne adults were divided into 5 groups and cultured on the Petri dishes in thermo-hydrostat controlled day and night at 28° C., under 70% for 24 hours and the mortality number of the test insects were measured 5 times with eyes and through a stereomicroscope( stemi-2000C, Xeiss), and the average mortality numbers were obtained. The death of the test insects was confirmed after irradiating light temporarily to the test insects and stimulating with a sharp stick the abdomens of the lasioderma serricorne adults and counting the number of unmoving insects. 100% of methanol was used in a control group. The result was listed in Table 1 and FIG. 1.

TABLE 1

| | The average mortality number |
|---|---|
| | of lasioderma serricorne |
| bark | 25 |
| wood | 3 |
| leaf | 19 |
| fruit | 10 |
| control group | 0 |
| (MeOH 100%) | |

According to Table 1 and FIG. 1, 25 out of 30 lasioderma serricorne were killed by the addition of bark extract (83.33% of mortality rate), 3 by the addition of the wood extract (10.00% of mortality rate), 19 by the addition of the leaf extract (63.33% of mortality rate), and 10 by the addition of the fruit extract (33.33%). Regarding the extracts of wood and fruit which exhibited relatively lower mortality rate, it was confirmed that lasioderma serricorne avoided the extracts and showed degraded vitality compared to control groups.

Accordingly, the extract of phellodendron amurense showed superior insect-repellent or insecticidal activities against lasioderma serricorne.

<2-2> Measurement of Insect-Repellent or Insecticidal Activities of Phellodendron Amurense Extract Against Sitophilus Oryzae

Fumigation method was used to measure insecticidal activities of phellodendron amurense extract against sitophilus oryzae.

250 μl of phellodendron amurense extract of Example 3 was filtered through a filter paper and placed on Petri dishes (50 mm). 30 sitophilus oryzae adults were divided into 5 groups and cultured on the Petri dishes in thermo-hydrostat controlled day and night at 28° C., under 70% for 24 hours and the mortality number of the test insects were measured 5 times with eyes and through a stereomicroscope (stemi-2000C, Xeiss), and the average mortality numbers were obtained. The death of the test insects was confirmed after irradiating light temporarily to the test insects and stimulating with a sharp stick the abdomens of the sitophilus oryzae adults and counting the number of unmoving insects. 100% of methanol was used in a control group. The result was listed in Table 2 and FIG. 2.

TABLE 2

| | The average mortality number |
|---|---|
| | of sitophilus oryzae |
| bark | 27 |
| wood | 10 |
| leaf | 21 |
| fruit | 15 |
| control group | 0 |
| (MeOH 100%) | |

Table 2 and FIG. 2 discloses that 27 out of 30 sitophilus oryzae were killed by the addition of the bark extract (90.00% of mortality rate), 10 by the addition of the wood extract (33.33% of mortality rate) 25 by the addition of the leaf extract (70.00% of mortality rate), and 15 by the addition of the fruit extract (50.00% of mortality rate). Regarding the extracts of wood and fruit which exhibited relatively lower mortality rate, it was confirmed that sitophilus oryzae avoided the extracts and showed degraded vitality compared to control groups.

Accordingly, the extract of phellodendron amurense showed superior insect-repellent or insecticidal activities against sitophilus oryzae.

<3-1> Measurement of Insecticidal Activities of Extract or Fraction of Phellodendron Amurense Bark Against Lasioderma Serricorne

The same method as that of <2-1> was applied, using methanol (MeOH) extract, hexan (Hex) fraction, methylene chloride (MC) fraction or ethyl acetate (EtOAc) fraction of phellodendron amurense bark to measure the average mortality number of lasioderma serricorne, and the result is listed in Table 3 and FIG. 3.

TABLE 3

| | The average mortality number |
|---|---|
| | of lasioderma serricorne |
| MeOH extract | 25 |
| Hex fraction | 3 |
| MC fraction | 27 |
| EtOAc fraction | 28 |
| control group | 0 |
| (MeOH 100%) | |

As shown in Table 3 and FIG. 3, 25 out of 30 lasioderma serricorne were killed by the addition of methanol (MeOH) extract (83.33% of mortality rate), 13 killed by the addition of hexane (Hex) fraction (43.33% of mortality rate), 27 killed by the addition of methylene chloride (MC) (90.00% of mortality rate), and 28 killed by the addition of ethyl acetate (EtOAc) fraction (93.33% of mortality rate).

Accordingly, the extract or fraction of the phellodendron amurense bark showed superior insecticidal activities against lasioderma serricorne.

<3-2> Measurement of Insecticidal Activities of Extract or Fraction of Phellodendron Amurense Leaf Against Lasioderma Serricorne

The same method as that of <2-1> was applied, using methanol (MeOH) extract, hexan (Hex) fraction, methylene chloride (MC) fraction or ethyl acetate (EtOAc) fraction of phellodendron amurense leaf to measure the average mortality number of lasioderma serricorne, and the result is listed in Table 4 and FIG. 4.

TABLE 4

| | The average mortality number |
|---|---|
| | of Lasioderma serricorne |
| MeOH extract | 19 |
| Hex fraction | 8 |
| MC fraction | 16 |
| EtOAc fraction | 21 |
| control group | 0 |
| (MeOH 100%) | |

According to Table 4 and FIG. 4, 19 out of 30 lasioderma serricorne were killed by the addition of methanol (MeOH) extract (63.33% of mortality rate), 8 killed by the addition of hexane (Hex) fraction (26.67% of mortality rate), 16 killed by the addition of methylene chloride (MC) (53.33% of mortality rate), and 21 killed by the addition of ethyl acetate (EtOAc) fraction (70.00% of mortality rate).

Accordingly, the extract or fraction of the phellodendron amurense leaf showed superior insecticidal activities against lasioderma serricorne.

<3-3> Measurement of Insecticidal Activities of Extract or Fraction of Phellodendron Amurense Fruit Against Lasioderma Serricorne

The same method as that of <2-1> was applied, using methanol (MeOH) extract, hexan (Hex) fraction, methylene chloride (MC) fraction or ethyl acetate (EtOAc) fraction of phellodendron amurense fruit to measure the average mortality number of lasioderma serricorne, and the result is listed in Table 5 and FIG. 5.

TABLE 5

| | The average mortality number |
|---|---|
| | of lasioderma serricorne |
| MeOH extract | 10 |
| Hex fraction | 5 |
| MC fraction | 7 |
| EtOAc fraction | 13 |
| control group | 0 |
| (MeOH 100%) | |

According to Table 5 and FIG. 5, 10 out of 30 lasioderma serricorne were killed by the addition of methanol (MeOH) extract (33.33% of mortality rate), 5 killed by the addition of hexane (Hex) fraction (16.67% of mortality rate), 7 killed by the addition of methylene chloride (MC) (23.33% of mortality rate), and 13 killed by the addition of ethyl acetate (EtOAc) fraction (43.33% of mortality rate).

Accordingly, the extract or fraction of the phellodendron amurense fruit showed superior insecticidal activities against lasioderma serricorne.

<4-1> Measurement of Insecticidal Activities of Extract or Fraction of Phellodendron Amurense Bark Against Sitophilus Oryzae

The same method as that of <2-2> was applied, using methanol (MeOH) extract, hexan (Hex) fraction, methylene chloride (MC) fraction or ethyl acetate (EtOAc) fraction of phellodendron amurense bark to measure the average mortality number of sitophilus oryzae, and the result is listed in Table 6 and FIG. 6.

TABLE 6

| | The average mortality number |
|---|---|
| | of sitophilus oryzae |
| MeOH extract | 27 |
| Hex fraction | 10 |
| MC fraction | 16 |
| EtOAc fraction | 30 |
| control group | 0 |
| (MeOH 100%) | |

According to Table 6 and FIG. 6, 27 out of 30 sitophilus oryzae were killed by the addition of methanol (MeOH) extract (90.00% of mortality rate), 10 killed by the addition of hexane (Hex) fraction (33.33% of mortality rate), 16 killed by the addition of methylene chloride (MC) (53.33% of mortality rate), and 30 killed by the addition of ethyl acetate (EtOAc) fraction (100.00%).

Accordingly, the extract or fraction of the phellodendron amurense bark showed superior insecticidal activities against sitophilus oryzae.

<4-2> Measurement of Insecticidal Activities of Extract or Fraction of Phellodendron Amurense Leaf Against Sitophilus Oryzae

The same method as that of <2-2>was applied, using methanol (MeOH) extract, hexan (Hex) fraction, methylene chloride (MC) fraction or ethyl acetate (EtOAc) fraction of phellodendron amurense leaf to measure the average mortality number of sitophilus oryzae, and the result is listed in Table 7 and FIG. 7.

TABLE 7

| | The average mortality number |
|---|---|
| | of sitophilus oryzae |
| MeOH extract | 21 |
| Hex fraction | 15 |
| MC fraction | 18 |
| EtOAc fraction | 26 |
| control group | 0 |
| (MeOH 100%) | |

According to Table 7 and FIG. 7, 21 out of 30 sitophilus oryzae were killed by the addition of methanol (MeOH) extract (70.00% of mortality rate), 15 killed by the addition of hexane (Hex) fraction (50.00% of mortality rate), 18 killed by the addition of methylene chloride (MC) (60.00% of mortality rate), and 26 killed by the addition of ethyl acetate (EtOAc) fraction (86.67% of mortality rate).

Accordingly, the extract or fraction of the phellodendron amurense leaf showed superior insecticidal activities against sitophilus oryzae.

<4-3> Measurement of Insecticidal Activities of Extract or Fraction of Phellodendron Amurense Fruit Against Sitophilus Oryzae

The same method as that of <2-2> was applied, using methanol (MeOH) extract, hexan (Hex) fraction, methylene chloride (MC) fraction or ethyl acetate (EtOAc) fraction of phellodendron amurense fruit to measure the average mortality number of sitophilus oryzae, and the result is listed in Table 8 and FIG. 8.

TABLE 8

| | The average mortality number |
|---|---|
| | of sitophilus oryzae |
| MeOH extract | 15 |
| Hex fraction | 5 |
| MC fraction | 11 |
| EtOAc fraction | 16 |
| control group | 0 |
| (MeOH 100%) | |

According to Table 8 and FIG. 8, 15 out of 30 sitophilus oryzae were killed by the addition of methanol (MeOH) (50.00% of mortality rate), 5 killed by the addition of hexane (Hex) fraction (16.67% of mortality rate), 11 killed by the addition of methylene chloride (MC) (36.67% of mortality rate), and 16 killed by the addition of ethyl acetate (EtOAc) fraction (53.33% of mortality rate).

Further, the extract or fraction of the phellodendron amurense fruit showed superior insecticidal activities against sitophilus oryzae.

Accordingly, the composition comprising extract or fraction of phellodendron amurense as an effective ingredient has superior insect-repellent or insecticidal activities against lasioderma serricorne, which damages tobacco, grains, paper or clothes, or against sitophilus oryzae, which has strong tolerance to insecticides, and therefore, can be applied effectively as an insect-repellent or insecticidal composition to conserve wooden furniture, an old house, or many organic cultural heritages.

1. A method for killing pests or insects inhabiting an organic object, comprising treating the pests or insects with an effective dose of a composition comprising an extract of phellodendron amurense or its organic solvent fraction.

2. The method of claim 1, wherein the extract comprises extracts obtained from fruit, bark, leaf, or wood of phellodendron amurense.

3. (canceled)

4. The method of claim 1, wherein the organic solvent fraction comprises a hexane (Hex) fraction, a methylene chloride (MC) fraction or an ethyl acetate (EtOAc) fraction.

5. The method of claim 1, wherein the pests or insects are lasioderma serricorne or sitophilus oryzae.

6-7. (canceled)

8. The method of claim 1, wherein treating the pests or insects comprises direct spraying, coating, fumigation, air freshing, or wrapping the object.

9. The method of claim 1, wherein the object comprises an organic cultural heritage.

10. The method of claim 9, wherein the object comprises a wood, paper, or textile object.

11. A method for resisting pests or insects inhabiting an organic object, comprising treating the object with an effective dose of a composition comprising an extract of phellodendron amurense or its organic solvent fraction.

12. The method of claim 11, wherein the pests or insects are Lasioderma serricorne or Sitophilus oryzae.

13. The method of claim 11, wherein treating the object comprises direct spraying, coating, fumigation, air freshing, or wrapping the object.

14. The method of claim 11, wherein the object is an organic cultural heritage.

15. The method of claim 14, wherein the object comprises a wood, paper, or textile object.

16. The method of claim 11, wherein the organic solvent fraction comprises a hexane (Hex) fraction, a methylene chloride (MC) fraction or an ethyl acetate (EtOAc) fraction.

17. A method of conserving an organic object, comprising treating the object with an effective dose of a composition comprising an extract or phellondendron amurense or its organic solvent fraction.

18. The method of claim 17, wherein the pests or insects are Lasioderma serricorne or Sitophilus oryzae.

19. The method of claim 17, wherein treating the object comprises direct spraying, coating, fumigation, air freshing, or wrapping the object.

20. The method of claim 17, wherein the object is an organic cultural heritage.

21. The method of claim 20, wherein the object comprises a wood, paper, or textile object.

22. The method of claim 17, wherein the organic solvent fraction comprises a hexane (Hex) fraction, a methylene chloride (MC) fraction or an ethyl acetate (EtOAc) fraction.
